(19) United States
(12) Patent Application Publication
(10) Pub. No.: US 2026/0005969 A1
(43) Pub. Date: Jan. 1, 2026

(54) CONTROL APPARATUS AND PRIORITY CONTROL METHOD

(71) Applicant: NIPPON TELEGRAPH AND TELEPHONE CORPORATION, Tokyo (JP)

(72) Inventors: Yuka OKAMOTO, Musashino-shi (JP); Hirotaka UJIKAWA, Musashino-shi (JP); Yoshihito SAKAI, Musashino-shi (JP); Tatsuya SHIMADA, Musashino-shi (JP)

(73) Assignee: NIPPON TELEGRAPH AND TELEPHONE CORPORATION, Tokyo (JP)

(21) Appl. No.: 18/869,109

(22) PCT Filed: Jun. 9, 2022
(86) PCT No.: PCT/JP2022/023291

§ 371 Date: Nov. 25, 2024

(51) Int. Cl. H04L 47/24; H04L 47/11

(52) U.S. Cl. CPC H04L 47/24; H04L 47/11

(57) ABSTRACT

A control device in a communication system in which one-way communication and round-trip communication coexist, the control device includes: a request delay acquisition unit that, based on cooperation information obtained from traffic transmitted from a plurality of wireless terminals and indicating a communication state between the plurality of wireless terminals and a base station that performs wireless communication, acquires information regarding a request delay and information regarding a priority in the traffic for each piece of the traffic; a traffic-based congestion calculation unit that calculates a congestion delay in a wired section on the basis of the information regarding the request delay and the information regarding the priority acquired for each piece of the traffic by the request delay acquisition unit; and a priority change control unit that, in a case where congestion occurs or a total delay requirement is not satisfied on the basis of the congestion delay in the wired section calculated by the traffic-based congestion calculation unit, transmits, to a relay device that relays the traffic, a control signal including an instruction to change at least a priority of traffic of the round-trip communication such that the traffic of the one-way communication is preferentially transmitted.

### TECHNICAL FIELD

The present invention relates to a control device and a priority control method.

### BACKGROUND ART

In conventional communication control based on priority assignment for implementing low-delay communication, one-way communication is controlled according to a delay requirement and a traffic amount. In the future, use cases of round-trip communication in which remote control is performed in real time on the basis of video, such as telemedicine, are expected to increase. In a case where real-time remote control is performed on the basis of video, a delay requirement in a round trip from transmission of video to reflection of control is a delay requirement as an application.

### CITATION LIST

### Non Patent Literature

Non Patent Literature 1: Chao Zhou, “Deadline and Priority-aware Congestion Control for Delay-sensitive Multimedia Streaming”, MM '21, Oct. 20-24, 2021.

Non Patent Literature 2: Bowen Bao, “TDTS: Three-Dimensional Traffic Scheduling in Optical Fronthaul Networks with Conv-LSTM”, Photonics 2021.

### Patent Literature

Patent Literature 1: JP 2020-14112 A

### SUMMARY OF INVENTION

### Technical Problem

In a system in which one-way communication and round-trip communication coexist, if all control is performed according to a delay requirement regarding the one-way communication as in conventional methods, control based on priority (e.g. path switching of a network) may be performed even in a case where the control does not need to be performed when considering the round-trip communication. As a result, highly accurate communication control based on required quality may not be implemented.

In view of the above circumstances, an object of the present invention is to provide a technique capable of implementing highly accurate communication control based on required quality in a system in which one-way communication and round-trip communication coexist.

### Solution to Problem

An aspect of the present invention is a control device in a communication system in which one-way communication and round-trip communication coexist, the control device including: a request delay acquisition unit that, based on cooperation information obtained from traffic transmitted from a plurality of wireless terminals and indicating a communication state between the plurality of wireless terminals and a base station that performs wireless communication, acquires information regarding a request delay and information regarding a priority in the traffic for each piece of the traffic; a traffic-based congestion calculation unit that calculates a congestion delay in a wired section on the basis of the information regarding the request delay and the information regarding the priority acquired for each piece of the traffic by the request delay acquisition unit; and a priority change control unit that, in a case where congestion occurs or a total delay requirement is not satisfied on the basis of the congestion delay in the wired section calculated by the traffic-based congestion calculation unit, transmits, to a relay device that relays the traffic, a control signal including an instruction to change a priority of traffic of the one-way communication or a priority of traffic of the round-trip communication such that the traffic of the one-way communication is preferentially transmitted.

An aspect of the present invention is a priority control method performed by a control device in a communication system in which one-way communication and round-trip communication coexist, the priority control method including: based on cooperation information obtained from traffic transmitted from a plurality of wireless terminals and indicating a communication state between the plurality of wireless terminals and a base station that performs wireless communication, acquiring information regarding a request delay and information regarding a priority in the traffic for each piece of the traffic; calculating a congestion delay in a wired section on the basis of the information regarding the request delay and the information regarding the priority acquired for each piece of the traffic; and, in a case where congestion occurs or a total delay requirement is not satisfied on the basis of the calculated congestion delay in the wired section, transmitting, to a relay device that relays the traffic, a control signal including an instruction to change a priority of traffic of the one-way communication or a priority of traffic of the round-trip communication such that the traffic of the one-way communication is preferentially transmitted.

### Advantageous Effects of Invention

According to the present invention, it is possible to implement highly accurate communication control based on required quality in a system in which one-way communication and round-trip communication coexist.

### BRIEF DESCRIPTION OF DRAWINGS

FIG. 1 An overall configuration of a mobile NW system in the present invention.

FIG. 2 A configuration example of each device in a mobile NW system in a first embodiment.

FIG. 3 A configuration example of a request delay calculation unit in the first embodiment.

FIG. 4 A configuration example of a traffic-based congestion calculation unit in the first embodiment.

FIG. 5 A processing in which the traffic-based congestion calculation unit in the first embodiment calculates a congestion delay for each priority.

FIG. 6 A flowchart showing a flow of processing of a control device in the first embodiment.

FIG. 7 A sequence diagram showing a flow of processing of the mobile NW system in the first embodiment.

FIG. 8 A configuration example of each device in a mobile NW system in a first modification example of the first embodiment.

FIG. 9 A configuration example of each device in a mobile NW system in a second embodiment.

FIG. 10 A configuration example of each device in a mobile NW system in a first modification example of the second embodiment.

FIG. 11 A configuration example of each device in a mobile NW system in a third embodiment.

FIG. 12 A flowchart showing a flow of processing of a control device in the third embodiment.

FIG. 13 A configuration example of each device in a mobile NW system in a first modification example of the third embodiment.

FIG. 14 A configuration example of each device in a mobile NW system in a fourth embodiment.

FIG. 15 A configuration example of each device in a mobile NW system in a first modification example of the fourth embodiment.

FIG. 16 A configuration example of each device in a mobile NW system in a fifth embodiment.

### DESCRIPTION OF EMBODIMENTS

Hereinafter, embodiments of the present invention will be described with reference to the drawings.

### Overall Configuration

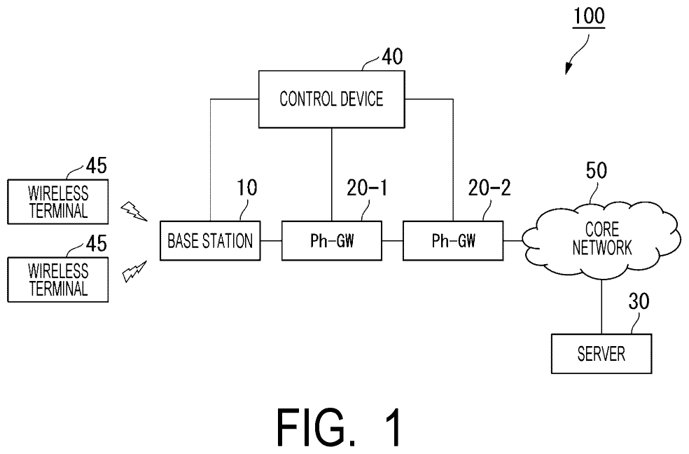

FIG. 1 shows an overall configuration of a mobile NW system 100 in the present invention. First, the overall configuration of the mobile NW system 100 will be described. The mobile NW system 100 is, for example, a fifth generation mobile communication system (hereinafter, referred to as “5G”). The mobile NW system 100 is an example of a communication system. The mobile NW system 100 includes one or more base stations 10, a plurality of Ph-GWs 20, a server 30, and a control device 40. The example in FIG. 1 shows one base station 10 and two Ph-GWs 20. Hereinafter, a direction from the base station 10 toward the server 30 will be referred to as an uplink direction, and a direction from the server 30 toward the base station 10 will be referred to as a downlink direction.

The base station 10 and a Ph-GW 20-1, the Ph-GW 20-1 and a Ph-GW 20-2, and the Ph-GW 20-2 and the server 30 are connected by an optical fiber that transmits optical signals. The base station 10 and the control device 40 and the Ph-GWs 20 and the control device 40 are connected by an electric wire that transmits electric signals or an optical fiber.

The base station 10 includes one or more antennas and performs wireless communication with a wireless terminal 45. For example, each base station 10 receives a signal indicating a traffic demand amount or actual traffic from the wireless terminal 45. The actual traffic is a signal addressed to the server 30. The traffic transmitted from the wireless terminal 45 is one-way traffic or round-trip traffic. Here, the one-way traffic is, for example, traffic that is transmitted from the wireless terminal 45 to the server 30 and does not require a response. The round-trip traffic is, for example, traffic transmitted from the wireless terminal 45 to the server 30 and requires a response to the traffic. The base station 10 is, for example, a distributed unit (DU) in a 5G communication standard. The base station 10 acquires cooperation information on the basis of the signal indicating the traffic demand amount.

The cooperation information is information indicating a state of communication between each base station 10 and the wireless terminal 45. The cooperation information includes, for example, wireless quality information. The cooperation information includes, for example, traffic assignment information. The cooperation information includes, for example, information regarding a delay. The wireless quality information is, for example, a 5G QoS Identifier (5QI) in the 5G communication standard. The traffic assignment information is a transport block size (TBS) or a buffer status report (BSR) for each logical channel.

The Ph-GW 20 is a relay device including an optical switch. In response to an instruction from the control device 40, the Ph-GW 20 changes a priority of traffic transmitted from the wireless terminal 45. Specifically, the Ph-GW 20 changes a priority of the round-trip traffic. For example, the Ph-GW 20 does not change a priority of the one-way traffic, but changes the priority of the round-trip traffic such that the priority of the round-trip traffic is lower than the priority of the one-way traffic.

The server 30 receives the traffic transmitted from the wireless terminal 45. In a case where the received traffic is the round-trip traffic, the server 30 provides the wireless terminal 45 with a response to the traffic transmitted from the wireless terminal 45. The server 30 is a host device.

The control device 40 acquires the cooperation information from the base station 10. Based on the acquired cooperation information, the control device 40 instructs the Ph-GW 20 to change a priority of traffic such that the one-way traffic is preferentially transmitted. Specifically, the control device 40 instructs the Ph-GW 20 to change the priority of the round-trip traffic. For example, the control device 40 causes the Ph-GW 20 not to change the priority of the one-way traffic, but to change the priority of the round-trip traffic such that the priority of the round-trip traffic is lower than the priority of the one-way traffic.

The wireless terminal 45 transmits traffic. The traffic transmitted by the wireless terminal 45 is a signal indicating the traffic demand amount or actual traffic that is transmission data addressed to the server 30. The wireless terminal 45 performs round-trip communication or one-way communication. The one-way communication is communication only in the uplink direction or the downlink direction. The round-trip communication is communication in the uplink direction and the downlink direction.

A core network 50 is, for example, an optical network.

### First Embodiment

In a first embodiment, there will be described a configuration in which, in a case where one-way communication is congested under a situation where round-trip communication and the one-way communication coexist, control is performed to satisfy a delay requirement by lowering a priority of the round-trip communication to reduce the congestion of the one-way communication.

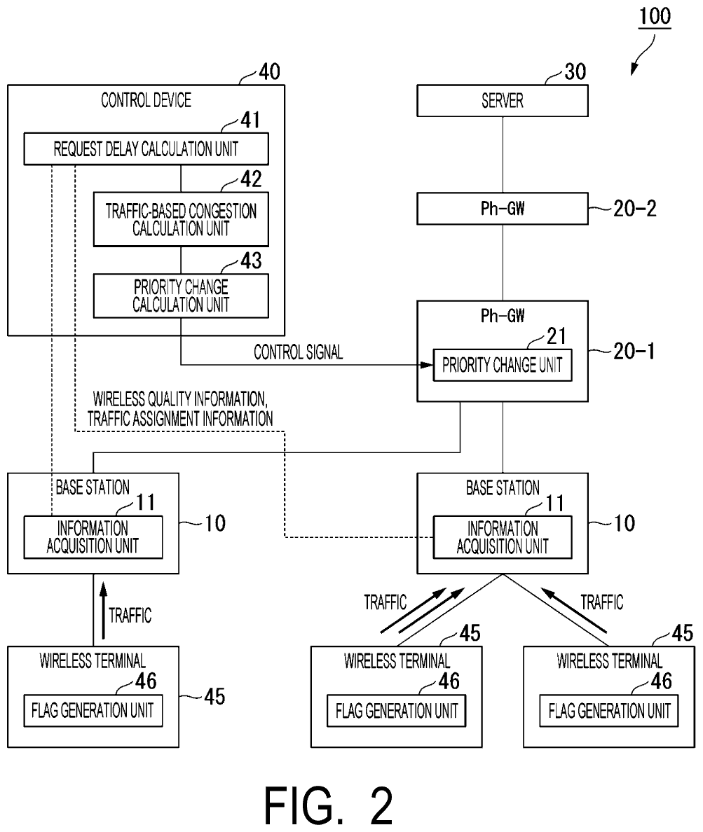

FIG. 2 shows a configuration example of each device in the mobile NW system 100 in the first embodiment. FIG. 2 shows the base stations 10, the Ph-GWs 20, the server 30, the control device 40, and the wireless terminals 45. Here, specific configurations of each base station 10, each Ph-GW 20, the control device 40, and each wireless terminal 45 will be described.

The wireless terminal 45 includes a flag generation unit 46. The flag generation unit 46 generates a flag for identifying whether the wireless terminal 45 performs the one-way communication or the round-trip communication. For example, the flag generation unit 46 generates a flag “0” in the case of the one-way communication and a flag “1” in the case of the round-trip communication. When transmitting a signal indicating the traffic demand amount or actual traffic, the wireless terminal 45 adds the flag generated by the flag generation unit 46 to the signal.

The base station 10 includes an information acquisition unit 11. The information acquisition unit 11 acquires wireless quality information, traffic assignment information, and flag information from the signal indicating the traffic demand amount transmitted from the wireless terminal 45. The information acquisition unit 11 transmits the acquired wireless quality information, traffic assignment information, and flag information to the control device 40 as the cooperation information. In a case where the base station 10 receives the actual traffic from the wireless terminal 45, the base station 10 transmits the received signal to the Ph-GW 20-1.

The control device 40 includes a request delay calculation unit 41, a traffic-based congestion calculation unit 42, and a priority change calculation unit 43. The request delay calculation unit 41 calculates a request delay and a priority of traffic for each piece of the traffic on the basis of the wireless quality information transmitted from the base station 10.

The traffic-based congestion calculation unit 42 rearranges signals transmitted from the respective wireless terminals 45 in accordance with the priority of the traffic calculated by the request delay calculation unit 41 and calculates a congestion delay on the basis of a band of a wired section acquired in advance.

In a case where the congestion delay occurs in the one-way communication on the basis of the congestion delay obtained by the traffic-based congestion calculation unit 42, the priority change calculation unit 43 instructs the Ph-GW 20-1 to change the priority of the traffic. Specifically, the priority change calculation unit 43 gives an instruction not to change the priority of the one-way communication, but to lower the priority of the round-trip communication. At this time, the priority change calculation unit 43 divides the priority into two categories of “high” and “low”. For example, in a case where both the priorities are 5, the priority change calculation unit 43 makes it possible to distinguish between, for example, priorities 5-1 and 5-0 in the same priority. The priority (5-1) indicating a high priority is given to the one-way communication of the same priority in which congestion occurs, and the priority (5-0) indicating a low priority is given to the round-trip communication of the same priority. The priority change calculation unit 43 generates a control signal including an instruction and transmits the control signal to the Ph-GW 20-1. The priority change calculation unit 43 is an example of a priority change controller.

The Ph-GW 20-1 includes a priority change unit 21. The priority change unit 21 changes a priority of designated traffic in response to a control signal transmitted from the control device 40. For example, the priority change unit 21 lowers the priority of the designated traffic in response to the control signal transmitted from the control device 40. A value of the priority to be lowered may be 1 or more. Therefore, the priority is lowered in the Ph-GW 20-1 in a case where a designated signal (signal of the round-trip communication) is obtained from the base station 10. As a result, a signal of the one-way communication is preferentially transmitted.

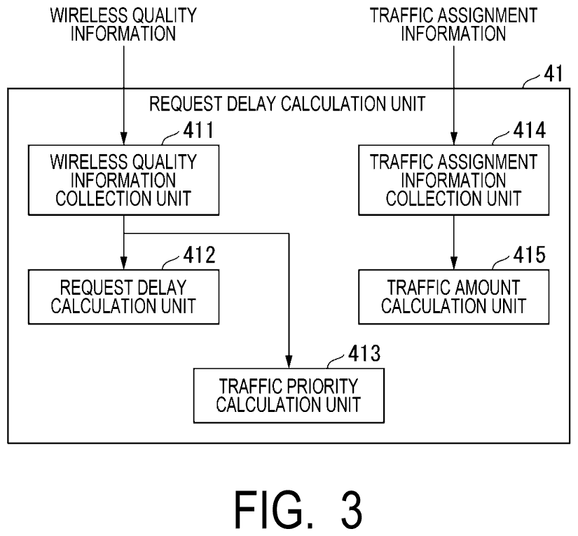

FIG. 3 shows a configuration example of the request delay calculation unit 41 in the first embodiment. The request delay calculation unit 41 includes a wireless quality information collection unit 411, a request delay calculation unit 412, a traffic priority calculation unit 413, a traffic assignment information collection unit 414, and a traffic amount calculation unit 415.

The wireless quality information collection unit 411 collects the wireless quality information included in the cooperation information transmitted from each base station 10. The wireless quality information collection unit 411 outputs the collected wireless quality information to the request delay calculation unit 412.

The request delay calculation unit 412 confirms mapping on the basis of the wireless quality information included in the cooperation information transmitted from each base station 10 and calculates a request delay.

The traffic priority calculation unit 413 confirms mapping on the basis of the wireless quality information included in the cooperation information transmitted from each base station 10 and determines a priority of traffic.

The traffic assignment information collection unit 414 collects the traffic assignment information (TBS or BSR) included in the cooperation information transmitted from each base station 10. The traffic assignment information collection unit 414 outputs the collected traffic assignment information to the traffic amount calculation unit 415.

The traffic amount calculation unit 415 determines a traffic amount on the basis of the traffic assignment information output from the traffic assignment information collection unit 414. The traffic amount calculation unit 415 may determine a value (value of TBS or BSR) indicated by the traffic assignment information as the traffic amount. The traffic amount calculation unit 415 may determine a value obtained by adding overhead to the value indicated by the traffic assignment information as the traffic amount.

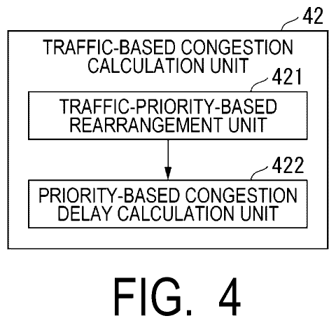

FIG. 4 shows a configuration example of the traffic-based congestion calculation unit 42 in the first embodiment. The traffic-based congestion calculation unit 42 includes a traffic-priority-based rearrangement unit 421 and a priority-based congestion delay calculation unit 422.

Information regarding the priority of the traffic determined by the traffic priority calculation unit 413 and information regarding the traffic amount determined by the traffic amount calculation unit 415 are input to the traffic-priority-based rearrangement unit 421. The traffic-priority-based rearrangement unit 421 rearranges pieces of traffic in order from the highest priority on the basis of the input information regarding the priority of the traffic and information regarding the traffic amount.

The priority-based congestion delay calculation unit 422 calculates a congestion delay by using the traffic amount, a link rate, and a queuing amount in order from the highest priority. Therefore, the priority-based congestion delay calculation unit 422 calculates a congestion delay of traffic for each priority. As calculation granularity, the calculation is performed at an interval shorter than the request delay from the viewpoint of a calculation time. The calculation may also be performed at a traffic transmission interval in a wireless section. Regardless of whether a calculation cycle is independent or common, the calculation is performed to satisfy the request delay in a case where the request delay is strict.

In a case where the request delay differs depending on the priority, traffic having a priority higher than a priority having a small request delay is determined according to the small request delay in order to reduce a calculation load. For example, in a case where a priority “high” has the request delay of 10 ms, a priority “medium” has the request delay of 5 ms, and a priority “low” has the request delay of 10 ms, the priority-based congestion delay calculation unit 422 calculates the congestion delay at an interval shorter than 5 ms for the priorities “high” and “medium” and calculates the congestion delay at an interval shorter than 10 ms for the priority “low”. The priority-based congestion delay calculation unit 422 performs the calculation in units of packets or bursts. In a case of (calculation in units of 1 us, in units of 5 ms), the calculation load decreases when a calculation interval is increased. Considering a difference in timing of a cycle of burst traffic, the unit may be mechanically 1 ms if the length is different between the uplink and the downlink by about a half of the request delay.

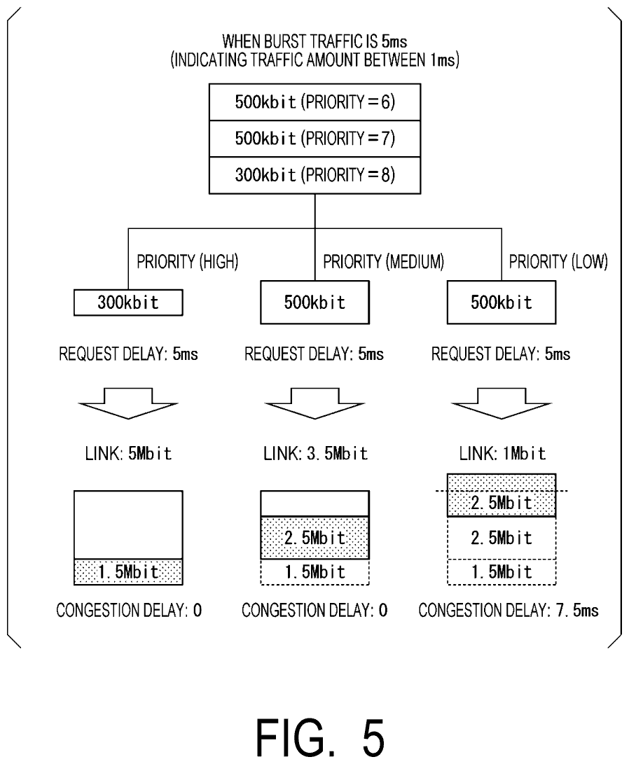

FIG. 5 shows processing in which the traffic-based congestion calculation unit 42 in the first embodiment calculates the congestion delay for each priority. As shown in FIG. 5, the traffic amount of 500 kbit (priority=6), the traffic amount of 500 kbit (priority=7), and the traffic amount of 300 kbit (priority=8) are input to the traffic-based congestion calculation unit 42. The traffic-priority-based rearrangement unit 421 first rearranges pieces of the input traffic in descending order of priority. Here, the traffic-priority-based rearrangement unit 421 rearranges the traffic amount of 300 kbit (priority=8) having the highest priority as the priority “high”, the traffic amount of 500 kbit (priority=7) having the next highest priority as the priority “medium”, and the traffic amount of 500 kbit (priority=6) having the lowest priority as the priority “low”.

The priority-based congestion delay calculation unit 422 assigns traffic in descending order of priority. Here, the request delay of each piece of the traffic is 5 ms, and the link rate is 5 Mbit. The traffic having the priority “high” is traffic of 1.5 Mbit (300 kbit×5 ms) for the link rate of 5 Mbit. Therefore, transmission can be performed without congestion. The traffic having the priority “medium” is traffic of 2.5 Mbit (500 kbit×5 ms) for the link rate of 5 Mbit−1.5 Mbit=3.5 Mbit. Therefore, transmission can be performed without congestion. Meanwhile, the traffic having the priority “low” is traffic of 2.5 Mbit (500 kbit×5 ms) for the link rate of 5 Mbit−1.5 Mbit−2.5 Mbit=1 Mbit. In this case, congestion of 1.5 Mbit occurs. Assuming that traffic corresponding to the congestion is processed at 200 Mbps (1 Mbit/5 ms), the priority-based congestion delay calculation unit 422 calculates the congestion delay as 1.5/200=7.5 ms.

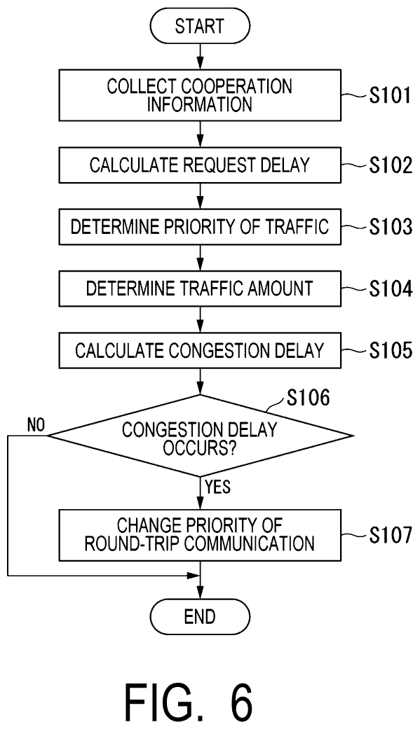

FIG. 6 is a flowchart showing a flow of processing of the control device 40 in the first embodiment.

The request delay calculation unit 41 collects cooperation information transmitted from each base station 10 (step S101). The request delay calculation unit 412 calculates a request delay for each piece of traffic on the basis of wireless quality information included in the cooperation information transmitted from each base station 10 (step S102). The traffic priority calculation unit 413 determines a priority for each piece of the traffic on the basis of the wireless quality information included in the cooperation information transmitted from each base station 10 (step S103). The traffic priority calculation unit 413 outputs information regarding the determined priority of each piece of the traffic to the traffic-based congestion calculation unit 42.

The traffic amount calculation unit 415 determines a traffic amount for each piece of the traffic on the basis of traffic assignment information included in the cooperation information transmitted from each base station 10 (step S104). The traffic amount calculation unit 415 outputs information regarding the determined traffic amount of each piece of the traffic to the traffic-based congestion calculation unit 42. The traffic-based congestion calculation unit 42 calculates a congestion delay on the basis of the information regarding the priority of each piece of the traffic output from the traffic priority calculation unit 413 and the information regarding the traffic amount of each piece of the traffic output from the traffic amount calculation unit 415 (step S105). The traffic-based congestion calculation unit 42 outputs information regarding the calculated congestion delay to the priority change calculation unit 43.

The priority change calculation unit 43 determines whether or not a congestion delay occurs on the basis of the information regarding the congestion delay output from the traffic-based congestion calculation unit 42 (step S106). For example, when the congestion delay is other than zero in the information regarding the congestion delay, the priority change calculation unit 43 determines that a congestion delay occurs. Meanwhile, when the congestion delay is zero in the information regarding the congestion delay, the priority change calculation unit 43 determines that no congestion delay occurs.

When the priority change calculation unit 43 determines that no congestion delay occurs (step S106—NO), the control device 40 ends the processing. When the priority change calculation unit 43 determines that a congestion delay occurs (step S106—YES), the priority change calculation unit 43 instructs the Ph-GW 20-1 to change the priority of the round-trip communication (step S107). Specifically, the priority change calculation unit 43 generates a control signal including an instruction to lower the priority of the round-trip communication. The priority change calculation unit 43 transmits the generated control signal to the Ph-GW 20-1.

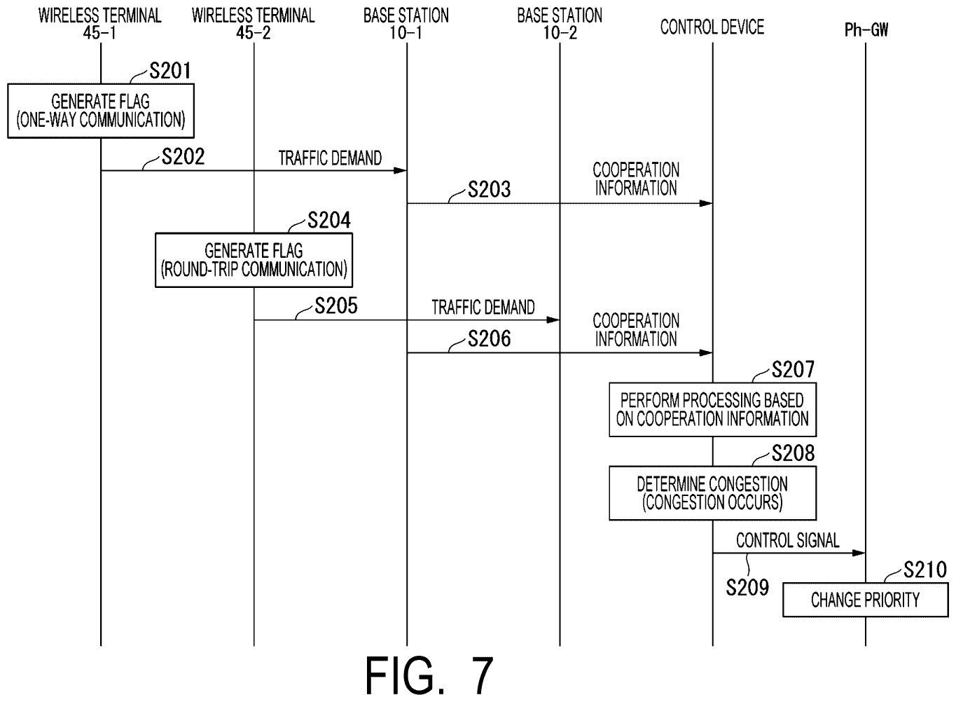

FIG. 7 is a sequence diagram showing a flow of processing of the mobile NW system 100 in the first embodiment. Here, in the description with reference to FIG. 7, a wireless terminal 45-1 is connected to a base station 10-1, and a wireless terminal 45-2 is connected to a base station 10-2.

The flag generation unit 46 of the wireless terminal 45-1 generates a flag indicating the one-way communication (step S201). The wireless terminal 45-1 adds the generated flag to traffic (e.g. a signal indicating the traffic demand amount) and transmits the traffic to the base station 10-1 (step S202). The base station 10-1 receives the traffic transmitted from the wireless terminal 45-1. The information acquisition unit 11 of the base station 10-1 acquires wireless quality information, traffic assignment information, and flag information from the received traffic. The information acquisition unit 11 of the base station 10-1 transmits the acquired wireless quality information, traffic assignment information, and flag information (e.g. “0” indicating the one-way communication) to the control device 40 as the cooperation information (step S203).

The flag generation unit 46 of the wireless terminal 45-2 generates a flag indicating the round-trip communication (step S204). The wireless terminal 45-2 adds the generated flag to traffic (e.g. a signal indicating the traffic demand amount) and transmits the traffic to the base station 10-2 (step S205). The base station 10-2 receives the traffic transmitted from the wireless terminal 45-2. The information acquisition unit 11 of the base station 10-2 acquires wireless quality information, traffic assignment information, and flag information from the received traffic. The information acquisition unit 11 of the base station 10-2 transmits the acquired wireless quality information, traffic assignment information, and flag information (e.g. “1” indicating the round-trip communication) to the control device 40 as the cooperation information (step S206).

The control device 40 collects the cooperation information transmitted from each of the base stations 10-1 and 10-2. The control device 40 performs processing based on the cooperation information on the basis of the collected cooperation information (step S207). Here, the processing based on the cooperation information is, for example, processing from step S102 to step S105 in FIG. 6. The control device 40 determines whether or not congestion occurs on the basis of the calculated congestion delay (step S208). Here, congestion occurs.

The control device 40 instructs the Ph-GW 20-1 to change the priority of the round-trip communication. Specifically, the control device 40 generates a control signal including an instruction to lower the priority of the round-trip communication. The control device 40 transmits the generated control signal to the Ph-GW 20-1 (step S209).

In response to the control signal transmitted from the control device 40, the priority change unit 21 of the Ph-GW 20-1 changes the priority of the target traffic of the round-trip communication (step S210). Specifically, when the target traffic of the round-trip communication is received from the base station 10, the priority change unit 21 of the Ph-GW 20-1 lowers the priority of the received traffic of the round-trip communication. As a result, when there is a plurality of pieces of traffic, the Ph-GW 20-1 preferentially transmits traffic of the one-way communication in the uplink direction. Whether or not the traffic transmitted from the base station 10 is the target traffic of the round-trip communication may be determined on the basis of the flag.

Next, specific processing in the first embodiment will be described by using a specific example.
<Input Flow> (Uplink direction: link 1 Gbps, transmission delay 0.8 ms)
One-way communication: 200 kbit (one way/priority 5/request delay 1 ms)
Round-trip communication (1): 500 kbit (one way/priority 5/request delay 1 ms-round trip 2 ms)
Round-trip communication (2): 600 kbit (one way/priority 5/request delay 1 ms-round trip 2 ms)
(Downlink direction: link 1 Gbps, transmission delay 0.8 ms)
Round-trip communication (1): 100 Mbps (one way/priority 5/request delay 1 ms-round trip 2 ms)
Round-trip communication (2): 100 Mbps (one way/priority 5/request delay 1 ms-round trip 2 ms) are defined.

In the related art, congestion of 0.3 ms occurs in uplink communication, and the one-way communication has a delay of 1.1 ms, which does not satisfy the delay requirement. Therefore, it is necessary to reduce an uplink traffic transmission amount or to balance a load of traffic of another path. However, there is a margin for the request delay in downlink communication, and thus, if the priority is changed at the time when congestion occurs, a total delay requirement may be satisfied. Therefore, when the priority is subdivided to give the priority (5-1) to the one-way communication and give a lowered priority (5-2) to the round-trip communication as described in the first embodiment, the following is obtained.
(Uplink direction: link 1 Gbps, transmission delay 0.8 ms)
One-way communication: 200 kbit (one way/priority 5-1/request delay 1 ms)
Round-trip communication (1): 500 kbit (one way/priority 5-2/request delay 1 ms-round trip 2 ms)
Round-trip communication (2): 600 kbit (one way/priority 5-2/request delay 1 ms-round trip 2 ms)
(Downlink direction: link 1 Gbps, transmission delay 0.8 ms)
Round-trip communication (1): 100 Mbps (one way/priority 5-2/request delay 1 ms-round trip 2 ms)
Round-trip communication (2): 100 Mbps (one way/priority 5-2/request delay 1 ms-round trip 2 ms) are obtained. Thus, the one-way communication has a delay of 0.8 ms, and the round-trip communication has a maximum round-trip delay of 1.98 ms, which indicates that the delay requirement is satisfied.

According to the mobile NW system 100 configured as described above, the control device 40 includes: the request delay calculation unit 41 that acquires information regarding a request delay and information regarding a priority in traffic for each piece of the traffic on the basis of cooperation information obtained from each base station 10; the traffic-based congestion calculation unit 42 that calculates a congestion delay in a wired section on the basis of the information regarding the request delay and the information regarding the priority acquired for each piece of the traffic; and the priority change calculation unit 43 that, in a case where congestion occurs on the basis of the congestion delay in the wired section, transmits, to the Ph-GW 20-1, a control signal including an instruction to change a priority of traffic of the round-trip communication such that traffic of the one-way communication is preferentially transmitted. Therefore, for traffic that does not satisfy the total (end-end in the case of one-way direction, and round trip in the case of the round-trip communication) delay requirement in conventional methods, it is possible to achieve communication that satisfies the delay requirement by lowering the priority of the round-trip communication. Therefore, it is possible to implement highly accurate communication control based on required quality in the mobile NW system 100 in which the one-way communication and the round-trip communication coexist.

### First Modification Example of First Embodiment

In the configuration described above, the Ph-GW 20 and the control device 40 determine whether traffic is traffic of the round-trip communication or traffic of the one-way communication on the basis of a flag added to the traffic. Meanwhile, the Ph-GW 20 and the control device 40 may determine whether traffic is traffic of the round-trip communication or traffic of the one-way communication on the basis of information of a wireless section such as NSSAI, DCN, ID, QoS flow ID, Bearer ID, PDU session ID, and DRB ID.

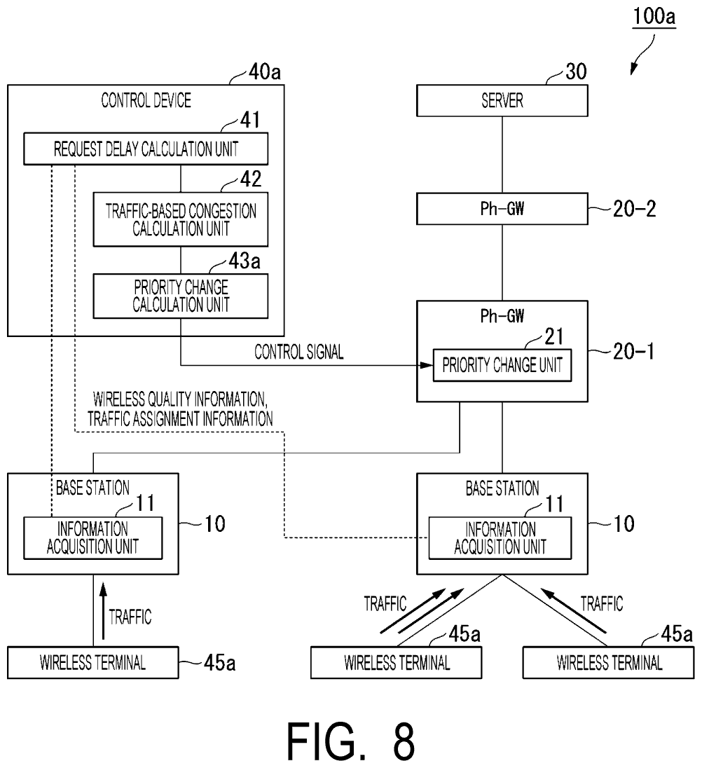

FIG. 8 shows a configuration example of each device in a mobile NW system 100a in a first modification example of the first embodiment. In the example of FIG. 8, as compared with FIG. 2, a wireless terminal 45a does not include the flag generation unit 46. Further, a control device 40a includes a priority change calculation unit 43a instead of the priority change calculation unit 43.

The priority change calculation unit 43a determines a target wireless section ID and a priority to be changed on the basis of the information of the wireless section. The target wireless section ID is information for identifying a wireless section whose priority is to be changed among wireless sections. Then, the priority change calculation unit 43a generates a control signal including the target wireless section ID and the priority to be changed. The priority change calculation unit 43a transmits the generated control signal to the Ph-GW 20-1. The priority change unit 21 of the Ph-GW 20-1 changes a priority of designated traffic in response to the control signal transmitted from the control device 40a. For example, the priority change unit 21 lowers the priority of the designated traffic in response to the control signal transmitted from the control device 40a. The priority change unit 21 determines the designated traffic on the basis of the information of the wireless section obtained in a section indicated by the target wireless section ID.

### Second Modification Example of First Embodiment

The embodiment described above shows a configuration in which the control device 40 instructs the Ph-GW 20 not to change the priority of the one-way traffic, but to lower the priority of the round-trip traffic such that the one-way traffic is preferentially transmitted. The control device 40 may give another instruction as long as the priority of the traffic can be changed such that the one-way traffic is preferentially transmitted. For example, the control device 40 may instruct the Ph-GW 20 not to change the priority of the round-trip traffic, but to give a higher priority to the one-way traffic than the priority of the round-trip traffic or may instruct the Ph-GW 20 to give a higher priority to the one-way traffic than the priority of the round-trip traffic and to give a lower priority to the round-trip traffic than the priority of the one-way traffic.

### Second Embodiment

In a second embodiment, there will be described a configuration in which, in a case where one-way communication is congested under a situation where round-trip communication and the one-way communication coexist, control is performed to maintain quality of traffic of the one-way communication by lowering the priority of the round-trip communication in the uplink direction and raising the priority of round-trip communication in the downlink direction.

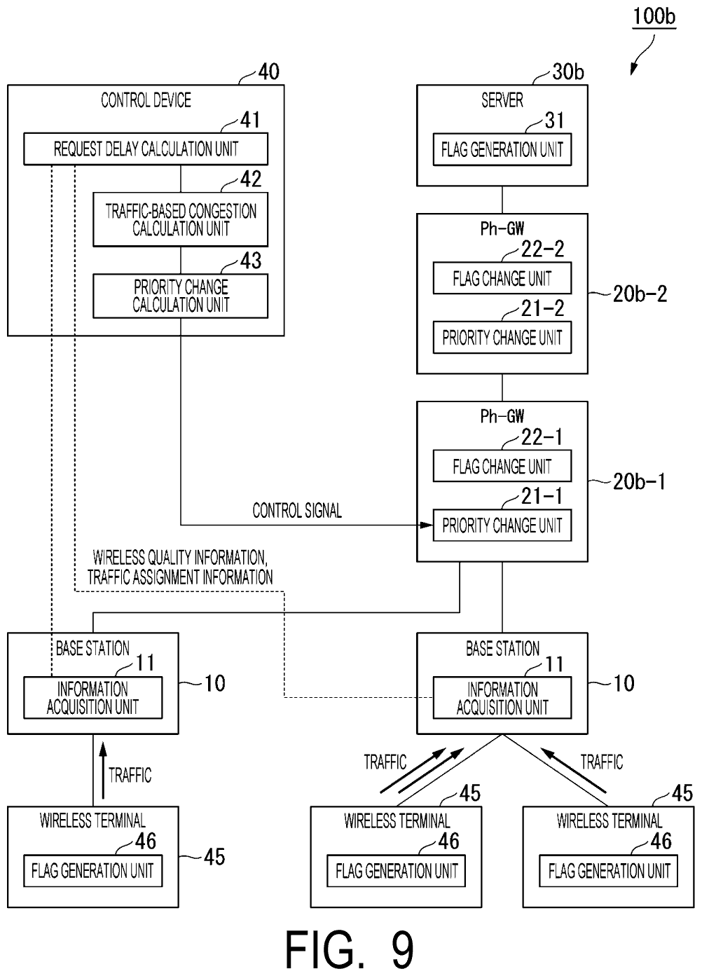

FIG. 9 shows a configuration example of each device in a mobile NW system 100b in the second embodiment. FIG. 9 shows base stations 10, Ph-GWs 20b, a server 30b, a control device 40, and wireless terminals 45. Here, specific configurations of each Ph-GW 20b and the server 30b will be described. Note that the configurations and processing of the base stations 10, the control device 40, and the wireless terminals 45 are similar to those of the first embodiment.

A Ph-GW 20b-1 changes a priority and flag of uplink traffic of the round-trip communication. The Ph-GW 20b-1 includes a priority change unit 21-1 and a flag change unit 22-1. The priority change unit 21-1 changes a priority of designated uplink traffic of the round-trip communication in response to a control signal transmitted from the control device 40. The flag change unit 22-1 changes the flag of the uplink traffic of the round-trip communication in order to raise a priority of downlink traffic of the round-trip communication. For example, the flag change unit 22-1 changes the flag of the uplink traffic of the round-trip communication from “1” indicating the round-trip communication to “2” indicating to raise the priority in the downlink direction.

A Ph-GW 20b-2 changes a priority and flag of the downlink traffic of the round-trip communication. The Ph-GW 20b-2 includes a priority change unit 21-2 and a flag change unit 22-2. In a case where a flag added to traffic acquired from the server 30b is a flag for raising a priority (e.g. “2” indicating to raise a priority), the flag change unit 22-2 changes the flag of the traffic acquired from the server 30b from “2” indicating to raise the priority to “1” indicating the round-trip communication.

In a case where the flag added to the traffic acquired from the server 30b is the flag for raising a priority (e.g. “2” indicating to raise a priority), the priority change unit 21-2 changes a priority of the traffic acquired from the server 30b. For example, the priority change unit 21-2 raises the priority of the traffic acquired from the server 30b by one (e.g. priority 5-1→5-2). When changing the priority, the priority change unit 21-2 may subdivide the priority as in the first embodiment or may change the priority on the basis of a normal priority (e.g. priority 5→6).

The server 30b receives uplink traffic and performs processing. The server 30b includes a flag generation unit 31. In a case where downlink traffic needs to be transmitted, the flag generation unit 31 generates a flag to be added to the downlink traffic and adds the flag to the downlink traffic. For example, the flag generation unit 31 adds a flag acquired in the uplink traffic. The case where the downlink traffic needs to be transmitted is, for example, a case where the uplink traffic from the wireless terminal 45 is obtained.

The mobile NW system 100b configured as described above can obtain the same effects as those of the first embodiment. In the mobile NW system 100b, the Ph-GW 20 changes the flag and the priority so as to lower the priority of the uplink traffic and raise the priority of the downlink traffic. This makes it possible to maintain the quality of the traffic of the one-way communication. As a result, it is possible to implement highly accurate communication control based on required quality in the mobile NW system 100b in which the one-way communication and the round-trip communication coexist.

### First Modification Example of Second Embodiment

In the configuration described above, the Ph-GW 20b and the control device 40 determine whether traffic is traffic of the round-trip communication or traffic of the one-way communication on the basis of the flag added to the traffic. Meanwhile, the Ph-GW 20b and the control device 40 may determine whether traffic is traffic of the round-trip communication or traffic of the one-way communication on the basis of information of a wireless section such as NSSAI, DCN, ID, QoS flow ID, Bearer ID, PDU session ID, and DRB ID.

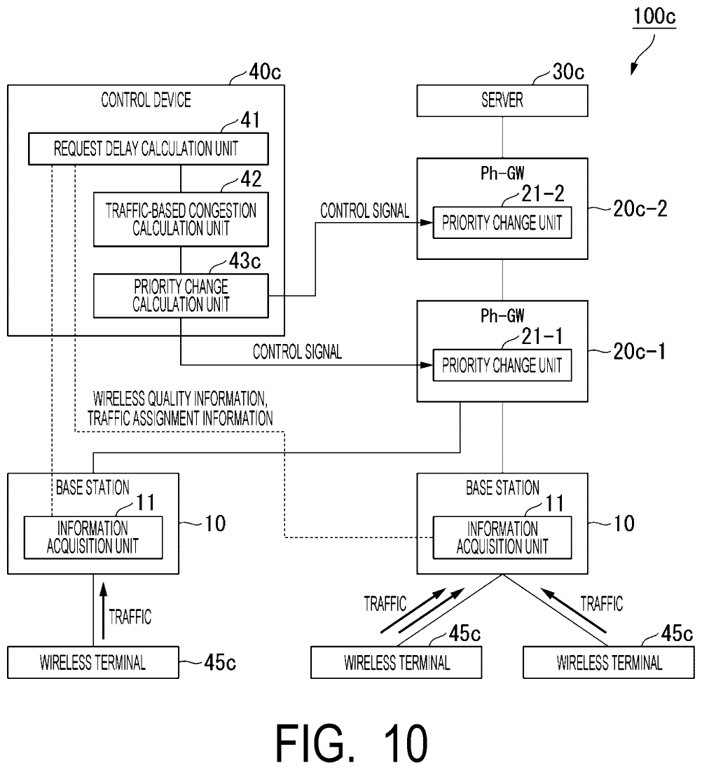

FIG. 10 shows a configuration example of each device in a mobile NW system 100c in a first modification example of the second embodiment. In the example of FIG. 10, as compared with FIG. 9, a Ph-GW 20c-1 does not include the flag change unit 22-1, a Ph-GW 20c-2 does not include the flag change unit 22-2, and a wireless terminal 45c does not include the flag generation unit 46. Further, a control device 40c includes a priority change calculation unit 43c instead of the priority change calculation unit 43.

The priority change calculation unit 43c determines a target wireless section ID and a priority to be changed on the basis of the information of the wireless section. Then, the priority change calculation unit 43c generates a control signal including the target wireless section ID and the priority to be changed. The priority change calculation unit 43c transmits the generated control signal to all the Ph-GWs 20c-1 and 20c-2. For example, the control device 40c determines current communication on the basis of the target wireless section ID of the traffic and transmits an instruction to lower the priority of the uplink traffic and raise the priority of the downlink traffic.

### Second Modification Example of Second Embodiment

The embodiment described above shows a configuration in which the control device 40 instructs the Ph-GW 20b to lower the priority of the round-trip communication in the uplink direction and raise the priority of the round-trip communication in the downlink direction such that the one-way traffic is preferentially transmitted. The control device 40 may give another instruction as long as the priority of the traffic can be changed such that the one-way traffic is preferentially transmitted. For example, the control device 40 may instruct the Ph-GW 20b not to change the priority of the uplink traffic of the round trip, but to give a higher priority to the one-way traffic than the priority of the uplink traffic of the round trip or may instruct the Ph-GW 20b to give a higher priority to the one-way traffic than the priority of the uplink traffic of the round trip and to give a lower priority to the uplink traffic of the round trip than the priority of the one-way traffic.

### Third Embodiment

In a third embodiment, there will be described a configuration in which, in a case where one-way communication does not satisfy a delay requirement in a situation where round-trip communication and the one-way communication coexist, control is performed to satisfy a request delay of total communication by changing the priority of the round-trip communication.

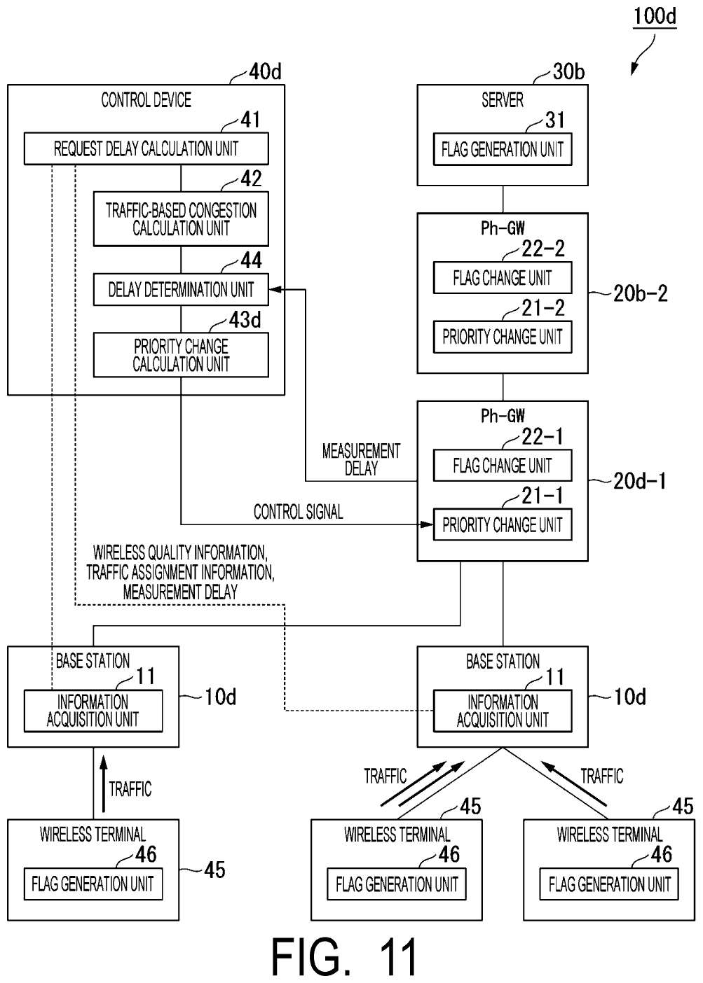

FIG. 11 shows a configuration example of each device in a mobile NW system 100d in the third embodiment. FIG. 11 shows base stations 10d, a Ph-GW 20d-1, a Ph-GW 20b-2, a server 30b, a control device 40d, and wireless terminals 45. Here, specific configurations of each base station 10d, the Ph-GW 20d-1, and the control device 40d will be described. Note that the configurations and processing of the server 30b, the Ph-GW 20b-2, and the wireless terminals 45 are similar to those of the second embodiment.

Each base station 10d performs processing similar to that of the first embodiment and the second embodiment. Further, the information acquisition unit 11 of the base station 10d further acquires delay information of a wireless section (section between the wireless terminal 45 and the base station 10d). The information acquisition unit 11 of the base station 10d transmits the acquired wireless quality information, traffic assignment information, flag information, and delay information to the control device 40d as the cooperation information.

The Ph-GW 20d-1 performs processing similar to that of the second embodiment. Further, the Ph-GW 20d-1 acquires delay information of a wired section. Delay measurement is performed by ping or the like. The Ph-GW 20d-1 transmits the acquired delay information of the wired section to the control device 40d.

The control device 40d includes a request delay calculation unit 41, a traffic-based congestion calculation unit 42, a priority change calculation unit 43d, and a delay determination unit 44. The control device 40d is different from the control device 40 in that the control device 40d includes the priority change calculation unit 43d instead of the priority change calculation unit 43 and newly includes a delay determination unit 44. Other configurations of the control device 40d are similar to those of the control device 40. Hereinafter, the priority change calculation unit 43d and the delay determination unit 44 will be described.

The delay determination unit 44 calculates a delay time on the basis of the delay information of the wired section acquired from the Ph-GW 20d-1, the delay information of the wireless section acquired from the base station 10d, and a congestion delay. The delay determination unit 44 determines whether or not the calculated delay time satisfies a request delay. For example, in a case where the delay time is within the request delay, the delay determination unit 44 determines that the delay time satisfies the request delay. Meanwhile, in a case where the delay time exceeds the request delay, the delay determination unit 44 determines that the delay time does not satisfy the request delay. Hereinafter, in a case where the delay time satisfies the request delay, it is described that a total delay requirement is satisfied, and, in a case where the delay time does not satisfy the request delay, it is described that the total delay requirement is not satisfied.

In a case where a request delay of the one-way direction is not satisfied and a request delay of the round-trip communication is satisfied as a result of changing a priority of traffic of the round-trip communication on the basis of the determination result of the delay determination unit 44, the priority change calculation unit 43d instructs the Ph-GW 20d-1 to change a priority of traffic.

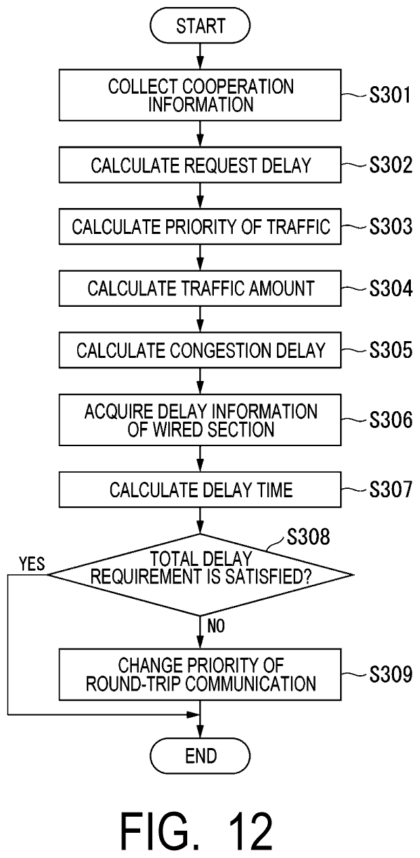

FIG. 12 is a flowchart showing a flow of processing of the control device 40d in the third embodiment.

The request delay calculation unit 41 collects cooperation information transmitted from each base station 10d (step S301). The request delay calculation unit 412 calculates a request delay for each piece of traffic on the basis of wireless quality information included in the cooperation information transmitted from each base station 10d (step S302). The traffic priority calculation unit 413 determines a priority for each piece of the traffic on the basis of the wireless quality information included in the cooperation information transmitted from each base station 10d (step S303). The traffic priority calculation unit 413 outputs information regarding the determined priority of each piece of the traffic to the traffic-based congestion calculation unit 42.

The traffic amount calculation unit 415 determines a traffic amount for each piece of the traffic on the basis of traffic assignment information included in the cooperation information transmitted from each base station 10d (step S304). The traffic amount calculation unit 415 outputs information regarding the determined traffic amount of each piece of the traffic to the traffic-based congestion calculation unit 42. The traffic-based congestion calculation unit 42 calculates a congestion delay on the basis of the information regarding the priority of each piece of the traffic output from the traffic priority calculation unit 413 and the information regarding the traffic amount of each piece of the traffic output from the traffic amount calculation unit 415 (step S305). The traffic-based congestion calculation unit 42 outputs information regarding the calculated congestion delay to the delay determination unit 44.

The delay determination unit 44 acquires delay information of a wired section from the Ph-GW 20d-1 (step S306). The delay determination unit 44 calculates a delay time on the basis of the delay information of the wired section acquired from the Ph-GW 20d-1, delay information of a wireless section included in the cooperation information transmitted from each base station 10d, and the congestion delay (step S307). The delay determination unit 44 outputs information regarding the calculated delay time to the priority change calculation unit 43d.

The priority change calculation unit 43d determines whether or not the calculated delay time satisfies the request delay, thereby determining whether or not the total delay requirement is satisfied (step S308). When the priority change calculation unit 43d determines that the total delay requirement is satisfied (step S308—YES), the control device 40d ends the processing. When the priority change calculation unit 43d determines that the total delay requirement is not satisfied (step S308—NO), the priority change calculation unit 43d instructs the Ph-GW 20d-1 to change the priority of the round-trip communication (step S309). Specifically, the priority change calculation unit 43d generates a control signal including an instruction to lower the priority of the round-trip communication. The priority change calculation unit 43d transmits the generated control signal to the Ph-GW 20d-1.

Next, specific processing in the third embodiment will be described by using a specific example.
(Uplink direction: link 1 Gbps, transmission delay 0.8 ms)
One-way communication: 200 kbit (one way/priority 5/request delay 1 ms)
Round-trip communication (1): 500 kbit (one way/priority 5/request delay 1 ms-round trip 2 ms)
Round-trip communication (2): 600 kbit (one way/priority 5/request delay 1 ms-round trip 2 ms)
(Downlink direction: link 1 Gbps, transmission delay 0.8 ms)
Round-trip communication (1): 100 Mbps (one way/priority 5/request delay 1 ms-round trip 2 ms)
Round-trip communication (2): 100 Mbps (one way/priority 5/request delay 1 ms-round trip 2 ms) are defined.

In the related art, congestion of 0.3 ms occurs in uplink communication, and the one-way communication has a delay of 1.1 ms, which does not satisfy the delay requirement. Therefore, it is necessary to reduce the uplink traffic transmission amount or to balance a load of traffic of another path. However, when calculation is performed to determine whether or not the request delay is satisfied also in consideration of downlink communication, request delay (2 ms)−transmission delay (0.8 ms+0.8 ms)=congestion delay up to 0.4 ms is allowable in a round trip in the round-trip communication, and thus the delay requirement is satisfied even in a case where the congestion delay of the uplink communication is 0.38 ms. Therefore, as described in the third embodiment, the priority of the round-trip communication that satisfies the delay requirement is lowered (priority 5→4). As a result, the following is obtained.
(Uplink direction: link 1 Gbps, transmission delay 0.8 ms)
One-way communication: 200 kbit (one way/priority 5/request delay 1 ms)
Round-trip communication (1): 500 kbit (one way/priority 4/request delay 1 ms-round trip 2 ms)
Round-trip communication (2): 600 kbit (one way/priority 4/request delay 1 ms-round trip 2 ms)
(Downlink direction: link 1 Gbps, transmission delay 0.8 ms)
Round-trip communication (1): 100 Mbps (one way/priority 5/request delay 1 ms-round trip 2 ms)
Round-trip communication (2): 100 Mbps (one way/priority 5/request delay 1 ms-round trip 2 ms) are obtained. Thus, the one-way communication has a delay of 0.8 ms, and the round-trip communication has a maximum round-trip delay of 1.98 ms, which indicates that the delay requirement is satisfied.

In a case where traffic of the one-way communication does not satisfy the delay requirement, the mobile NW system 100d configured as described above determines whether or not the total delay requirement is satisfied by changing the priority of the round-trip communication. Then, only in a case where the total delay requirement is satisfied by changing the priority of the traffic of the round-trip communication, the mobile NW system 100d changes the priority of the traffic of the round-trip communication. This makes it possible to suppress unnecessary control.

### First Modification Example of Third Embodiment

In the configuration described above, the Ph-GWs 20b-1 and 20d-1 and the control device 40d determine whether traffic is traffic of the round-trip communication or traffic of the one-way communication on the basis of the flag added to the traffic. Meanwhile, the Ph-GWs 20b-1 and 20d-1 and the control device 40d may determine whether traffic is traffic of the round-trip communication or traffic of the one-way communication on the basis of information of a wireless section such as NSSAI, DCN, ID, QoS flow ID, Bearer ID, PDU session ID, and DRB ID.

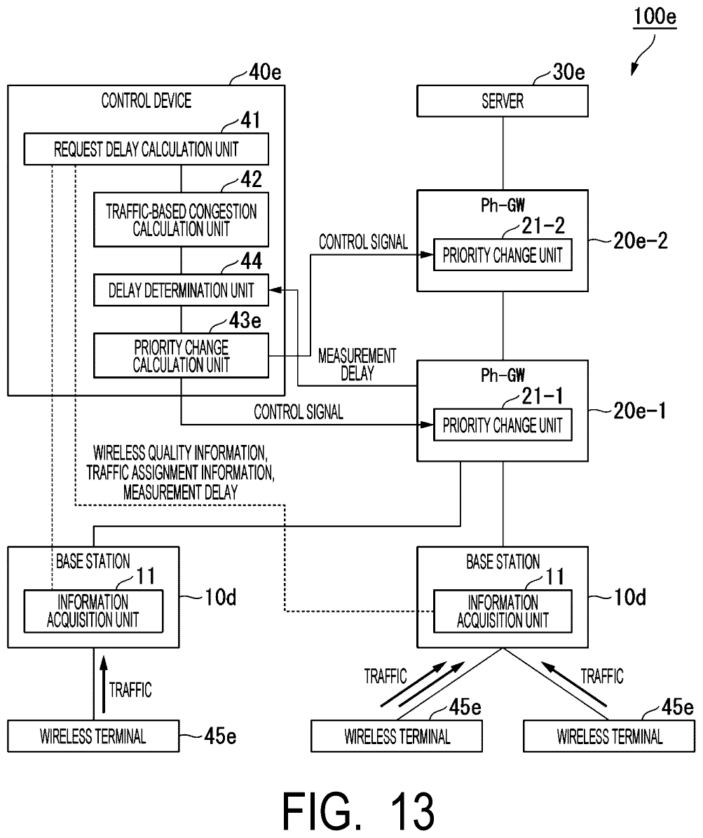

FIG. 13 shows a configuration example of each device in a mobile NW system 100e in a first modification example of the third embodiment. In the example of FIG. 13, as compared with FIG. 11, a Ph-GW 20e-1 does not include the flag change unit 22-1, a Ph-GW 20e-2 does not include the flag change unit 22-2, and a wireless terminal 45e does not include the flag generation unit 46. Further, the control device 40e includes a priority change calculation unit 43e instead of the priority change calculation unit 43d.

The priority change calculation unit 43e determines a target wireless section ID and a priority to be changed on the basis of the information of the wireless section. Then, the priority change calculation unit 43e generates a control signal including the target wireless section ID and the priority to be changed. The priority change calculation unit 43e transmits the generated control signal to all the Ph-GWs 20e-1 and 20e-2. For example, the control device 40e determines current communication on the basis of the target wireless section ID of the traffic and transmits an instruction to lower a priority of uplink traffic and raise a priority of downlink traffic.

### Second Modification Example of Third Embodiment

The embodiment described above shows a configuration in which the control device 40d instructs the Ph-GW 20d to give a lower priority to the traffic of the round-trip communication than the priority of the one-way traffic such that the one-way traffic is preferentially transmitted. The control device 40d may give another instruction as long as the priority of the traffic can be changed such that the one-way traffic is preferentially transmitted. For example, the control device 40d may instruct the Ph-GW 20d not to change the priority of the round-trip traffic, but to give a higher priority to the one-way traffic than the priority of the round-trip traffic or may instruct the Ph-GW 20d to give a higher priority to the one-way traffic than the priority of the round-trip traffic and to give a lower priority to the round-trip traffic than the priority of the one-way traffic.

### Fourth Embodiment

In a fourth embodiment, there will be described a configuration in which, in a case where one-way communication does not satisfy a delay requirement in a situation where round-trip communication and the one-way communication coexist, control is performed to satisfy a request delay of total communication by changing a priority of uplink traffic in advance.

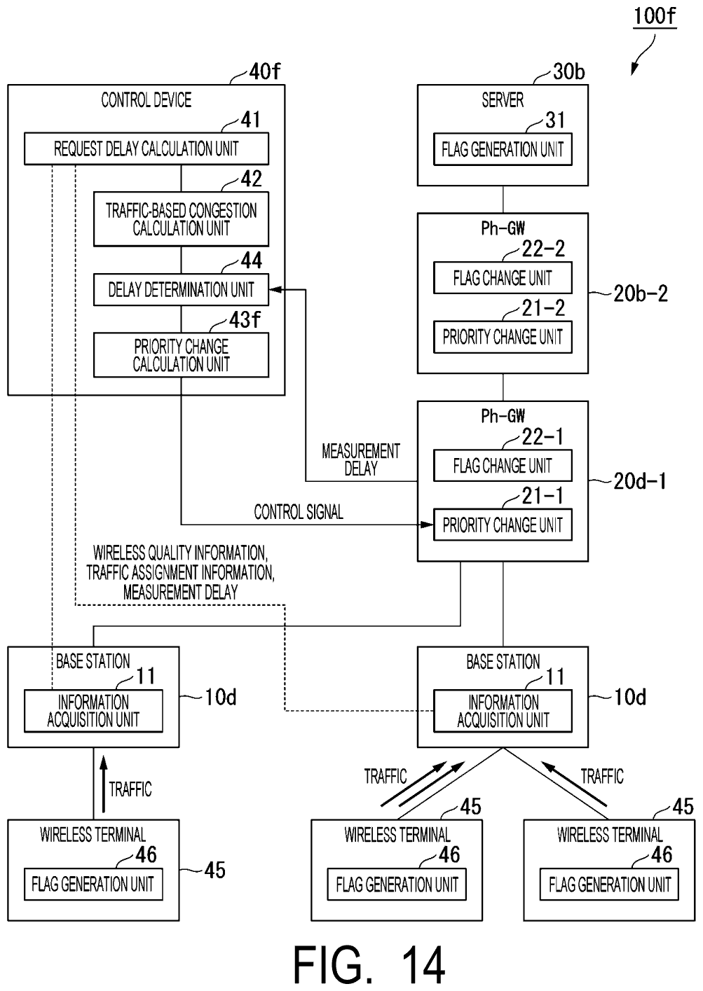

FIG. 14 shows a configuration example of each device in a mobile NW system 100f in the fourth embodiment. FIG. 14 shows base stations 10d, a Ph-GW 20d-1, a Ph-GW 20b-2, a server 30b, a control device 40f, and wireless terminals 45. Here, a specific configuration of the control device 40f will be described. Other configurations and processing are similar to those of the third embodiment.

The control device 40f includes a request delay calculation unit 41, a traffic-based congestion calculation unit 42, a priority change calculation unit 43f, and a delay determination unit 44. The control device 40f is different from the control device 40d in that the control device 40f includes the priority change calculation unit 43f instead of the priority change calculation unit 43d. In a case where there is round-trip communication that does not satisfy the delay requirement on the basis of a determination result of the delay determination unit 44 and in a case where all communication satisfies the request delay as a result of changing a priority, the priority change calculation unit 43f instructs the Ph-GW 20d-1 to change a priority of traffic. Specifically, the priority change calculation unit 43f subdivides the priority into two categories of “high” and “low”. For example, in a case where both the priorities are 5, the priority change calculation unit 43f makes it possible to distinguish between, for example, priorities 5-1 and 5-0 in the same priority. The priority (5-1) indicating a high priority is given to the one-way communication of the same priority in which congestion occurs, and the priority (5-0) indicating a low priority is given to the round-trip communication of the same priority.

The control device 40f is different from the control device 40d in the third embodiment in that, in a case where congestion increases in downlink communication (return path) and the delay requirement is not satisfied, the control device 40f performs control to satisfy the delay requirement by performing determination in advance in uplink communication (outward path) and increasing QoS control-priority.

Next, specific processing in the fourth embodiment will be described by using a specific example.
(Uplink direction: link 1 Gbps, transmission delay 0.8 ms)
One-way communication (1): 700 kbit (one way/priority 5/request delay 1 ms)
Round-trip communication (1): 200 kbit (one way/priority 5/request delay 1 ms-round trip 2 ms)
Round-trip communication (2): 200 kbit (one way/priority 5/request delay 1 ms-round trip 2 ms)
(Downlink direction: link 1 Gbps, transmission delay 0.8 ms)
One-way communication (2): 100 kbit (one way/priority 5/request delay 1 ms)
Round-trip communication (1): 700 kbit (one way/priority 5/request delay 1 ms-round trip 2 ms)
Round-trip communication (2): 600 kbit (one way/priority 5/request delay 1 ms-round trip 2 ms) are defined.

In the related art, congestion of 0.1 ms occurs in the uplink communication, and congestion of 0.4 ms occurs in the downlink communication. Thus, the round-trip communication (1) has a delay of 2.1 ms, which does not satisfy a round-trip delay requirement. Therefore, it is necessary to reduce a downlink traffic transmission amount or to balance a load of traffic of another path. However, when calculation is performed to determine whether or not the request delay is satisfied also in consideration of the downlink communication at the time of the uplink communication, a congestion delay of up to 0.4 ms is allowable in a round trip in the round-trip communication, and a congestion of up to 0.2 ms is allowable in the one-way communication of the uplink communication. Thus, both the one-way communication and the round-trip communication satisfy the delay requirement as a total delay when congestion is placed on uplink one-way communication. Therefore, as described in the fourth embodiment, the priority change calculation unit 43f gives an instruction to raise the priority (priority 5→6) of the round-trip communication that satisfies the delay requirement. Further, regarding the downlink, the priority change calculation unit 43f gives an instruction to lower the priority of the round-trip communication (priority 5→4) so as to satisfy the delay requirement of the one-way communication. As a result, the following is obtained.
(Uplink direction: link 1 Gbps, transmission delay 0.8 ms)
One-way communication (1): 700 kbit (one way/priority 5/request delay 1 ms)
Round-trip communication (1): 200 kbit (one way/priority 6/request delay 1 ms-round trip 2 ms)
Round-trip communication (2): 200 kbit (one way/priority 6/request delay 1 ms-round trip 2 ms)
(Downlink direction: link 1 Gbps, transmission delay 0.8 ms)
One-way communication (2): 100 kbit (one way/priority 5/request delay 1 ms)
Round-trip communication (1): 700 kbit (one way/priority 4/request delay 1 ms-round trip 2 ms)
Round-trip communication (2): 600 kbit (one way/priority 4/request delay 1 ms-round trip 2 ms) are obtained. Thus, the one-way communication (1) has a delay of 0.96 ms, the round-trip communication has a round-trip delay of 1.94 ms, and the one-way communication (2) has a delay of 0.8 ms, which indicates that the delay requirement is satisfied.

In a case where there is round-trip communication that does not satisfy the delay requirement, the mobile NW system 100f configured as described above determines whether or not all communication satisfies the request delay as a result of changing the priority of the traffic of the round-trip communication. In a case where all the communication satisfies the request delay, the mobile NW system 100f changes the priority of the traffic of the round-trip communication. As described above, the mobile NW system 100f determines in advance whether or not the request delay is satisfied on the basis of the uplink communication and performs control to satisfy the delay requirement. As a result, it is possible to implement highly accurate communication control based on required quality in the mobile NW system 100f in which the one-way communication and the round-trip communication coexist.

### First Modification Example of Fourth Embodiment

In the configuration described above, the Ph-GWs 20b-1 and 20d-1 and the control device 40f determine whether traffic is traffic of the round-trip communication or traffic of the one-way communication on the basis of the flag added to the traffic. Meanwhile, the Ph-GWs 20b-1 and 20d-1 and the control device 40f may determine whether traffic is traffic of the round-trip communication or traffic of the one-way communication on the basis of information of a wireless section such as NSSAI, DCN, ID, QoS flow ID, Bearer ID, PDU session ID, and DRB ID.

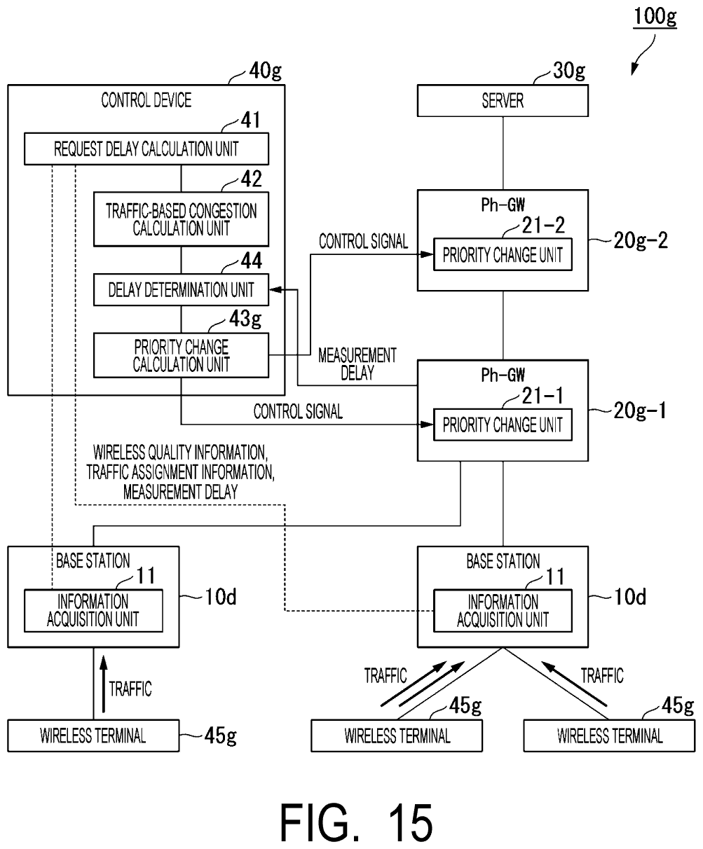

FIG. 15 shows a configuration example of each device in a mobile NW system 100g in a first modification example of the fourth embodiment. In the example of FIG. 15, as compared with FIG. 14, a Ph-GW 20g-1 does not include the flag change unit 22-1, a Ph-GW 20g-2 does not include the flag change unit 22-2, and a wireless terminal 45g does not include the flag generation unit 46. Further, the control device 40g includes a priority change calculation unit 43g instead of the priority change calculation unit 43f.

The priority change calculation unit 43g determines a target wireless section ID and a priority to be changed on the basis of the information of the wireless section. Then, the priority change calculation unit 43g generates a control signal including the target wireless section ID and the priority to be changed. The priority change calculation unit 43g transmits the generated control signal to all the Ph-GWs 20g-1 and 20g-2. For example, the control device 40g determines current communication on the basis of the target wireless section ID of the traffic and transmits an instruction to lower a priority of uplink traffic and raise a priority of downlink traffic.

### Second Modification Example of Fourth Embodiment

Regarding the calculation of the congestion delay, the control device 40f may change the priority by using the traffic amount as in the first embodiment and the second embodiment, instead of changing the priority in advance by using a traffic assignment amount.

### Third Modification Example of Fourth Embodiment

In the embodiment described above, the control device 40f instructs the Ph-GW 20d to raise the priority of the round-trip communication that satisfies the delay requirement and, regarding the downlink, lower the priority of the round-trip communication so as to satisfy the delay requirement of the one-way communication such that the one-way traffic is preferentially transmitted. The control device 40f may give another instruction as long as the priority of the traffic can be changed such that the one-way traffic is preferentially transmitted.

### Fifth Embodiment

In a fifth embodiment, there will be described a configuration in which control is performed to satisfy a delay requirement of an application including a processing delay time of a server as a round-trip delay time.

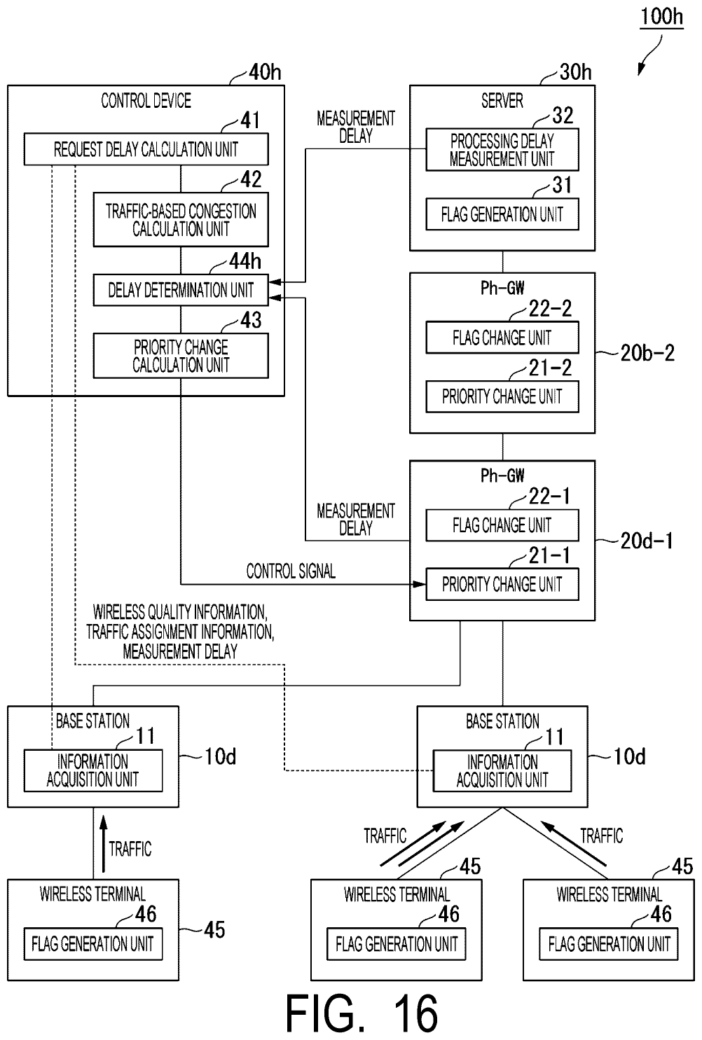

FIG. 16 shows a configuration example of each device in a mobile NW system 100h in the fifth embodiment. FIG. 16 shows base stations 10d, a Ph-GW 20d-1, a Ph-GW 20b-2, a server 30h, a control device 40h, and wireless terminals 45. Here, specific configurations of the server 30h and the control device 40h will be described. Other configurations and processing are similar to those of the third embodiment and the fourth embodiment.

The server 30h includes a flag generation unit 31 and a processing delay measurement unit 32. In a case where downlink traffic needs to be transmitted, the flag generation unit 31 generates a flag to be added to the downlink traffic and adds the flag to the downlink traffic.

The processing delay measurement unit 32 measures a delay time regarding processing of the server 30h (hereinafter, referred to as “processing delay time”) at regular intervals. More specifically, the processing delay measurement unit 32 measures a processing time from reception of uplink traffic to transmission of downlink traffic as the processing delay time. The processing delay measurement unit 32 transmits information regarding the measured processing delay time to the control device 40h. As a method of issuing the information regarding the processing delay time, the information may be directly issued from the server 30h in a wireless manner or the like or may be issued by using a transmission path through which a main signal flows.

The processing delay measurement unit 32 may perform measurement when a new flow occurs and do not perform subsequent measurement or may store a relationship between the traffic amount and the processing delay time of the server 30 in advance. The processing delay measurement unit 32 may perform feedback on the basis of the measured delay time from the processing delay time measured in advance. This is effective for reducing a measurement interval and improving delay accuracy.

The control device 40h includes a request delay calculation unit 41, a traffic-based congestion calculation unit 42, a priority change calculation unit 43, and a delay determination unit 44h. The control device 40h is different from the control device 40d in that the control device 40h includes the delay determination unit 44h instead of the delay determination unit 44.

The delay determination unit 44h calculates a delay time on the basis of delay information of a wired section acquired from the Ph-GW 20d-1, delay information of a wireless section acquired from the base station 10d, a congestion delay, and the information regarding the processing delay time acquired from the server 30h. The delay determination unit 44h determines whether or not the calculated delay time satisfies a request delay.

The priority change calculation unit 43 changes a priority by the method described in the third embodiment or the fourth embodiment on the basis of the delay time calculated by the delay determination unit 44h.

The mobile NW system 100h configured as described above calculates the delay time including the processing delay of the server 30h. As described above, the mobile NW system 100h can determine whether or not the delay requirement of the application is satisfied by including the processing delay of the server 30h. As a result, it is possible to implement highly accurate communication control based on required quality in the mobile NW system 100h in which one-way communication and round-trip communication coexist.

### First Modification Example of Fifth Embodiment

The fifth embodiment may be modified in a similar manner to the fourth embodiment.

Some or all of the functional units of the above control devices 40, 40a, 40c, 40d, 40e, 40f, 40g, and 40h are implemented as software by causing a processor such as a central processing unit (CPU) to execute a program stored in a storage device including a nonvolatile recording medium (non-transitory recording medium) and a storage unit. The program may be recorded in a computer-readable non-transitory recording medium. The computer-readable non-transitory recording medium is a non-transitory recording medium such as a portable medium including a flexible disk, a magneto-optical disk, a read only memory (ROM), and a compact disc read only memory (CD-ROM) or a storage device such as a hard disk built in a computer system.

Some or all of the functional units of the above control devices 40, 40a, 40c, 40d, 40e, 40f, 40g, and 40h may be implemented by using hardware including an electronic circuit (or circuitry) using, for example, a large scale integrated circuit (LSI), an application specific integrated circuit (ASIC), a programmable logic device (PLD), or a field programmable gate array (FPGA).

Although the embodiments of the present invention have been described in detail with reference to the drawings, specific configurations are not limited to the present embodiments and include design and the like within the scope of the present invention.

### INDUSTRIAL APPLICABILITY

The present invention can be applied to an optical communication system technology such as an optical access system in which one-way communication and round-trip communication coexist.

### REFERENCE SIGNS LIST

10, 10d Base station
11 Information acquisition unit
20, 20-1 to 20-2, 20b-1 to 20b-2, 20d-1 Ph-GW
21 Priority change unit
22 Flag change unit
30 Server
31 Flag generation unit
32 Processing delay measurement unit
40, 40a, 40c, 40d, 40e, 40f, 40g, 40h Control device
41 Request delay calculation unit
42 Traffic-based congestion calculation unit
43, 43a, 43c, 43d, 43e, 43f, 43g, 43h Priority change calculation unit
44 Delay determination unit
45 Wireless terminal
46 Flag generation unit
50 Core network
100, 100a, 100b, 100c, 100d, 100e, 100f, 100g, 100h Mobile NW system
411 Wireless quality information collection unit
412 Request delay calculation unit
413 Traffic priority calculation unit
414 Traffic assignment information collection unit
415 Traffic amount calculation unit
421 Traffic-priority-based rearrangement unit
422 Priority-based congestion delay calculation unit

1. A control device in a communication system in which one-way communication and round-trip communication coexist, the control device comprising:
a request delay acquirer configured to, based on cooperation information obtained from traffic transmitted from a plurality of wireless terminals and indicating a communication state between the plurality of wireless terminals and a base station that performs wireless communication, acquire information regarding a request delay and information regarding a priority in the traffic for each piece of the traffic;
a traffic-based congestion calculator configured to calculate a congestion delay in a wired section on the basis of the information regarding the request delay and the information regarding the priority acquired for each piece of the traffic by the request delay acquirer; and
a priority change controller configured to, in a case where congestion occurs or a total delay requirement is not satisfied on the basis of the congestion delay in the wired section calculated by the traffic-based congestion calculator, transmit, to a relay device that relays the traffic, a control signal including an instruction to change a priority of traffic of the one-way communication or a priority of traffic of the round-trip communication such that the traffic of the one-way communication is preferentially transmitted.

2. The control device according to claim 1, wherein:
a flag for identifying whether traffic is the traffic of the one-way communication or the traffic of the round-trip communication is added to the traffic transmitted from the plurality of wireless terminals; and
the priority change controller identifies whether each piece of the traffic transmitted from the plurality of wireless terminals is the traffic of the one-way communication or the traffic of the round-trip communication on the basis of the flag added to the traffic and transmits, to the relay device, a control signal including an instruction to change a priority of any piece of the identified traffic.

3. The control device according to claim 1, wherein:
the priority change controller transmits, to the relay device, a control signal including any of
an instruction not to change the priority of the traffic of the round-trip communication, but to give a higher priority to the traffic of the one-way communication than the priority of the traffic of the round-trip communication,
an instruction not to change the priority of the traffic of the one-way communication, but to give a lower priority to the traffic of the round-trip communication than the priority of the traffic of the one-way communication, and
an instruction to give a higher priority to the traffic of the one-way communication than the priority of the traffic of the round-trip communication and give a lower priority to the traffic of the round-trip communication than the priority of the traffic of the one-way communication.

4. The control device according to claim 1, wherein:
the cooperation information includes at least delay information of a wireless section between the plurality of wireless terminals and the base station;
the control device further includes a delay determiner configured to calculate a delay time on the basis of delay information of the wired section obtained from the relay device, the delay information of the wireless section included in the cooperation information, and the congestion delay in the wired section calculated by the traffic-based congestion calculator and determines whether or not the calculated delay time satisfies the request delay; and
the priority change controller transmits the control signal including the instruction to the relay device in a case where the delay time does not satisfy the request delay and satisfies the request delay of the round-trip communication as a result of changing the priority of the traffic of the round-trip communication.

5. The control device according to claim 1, wherein:
the cooperation information includes at least delay information of a wireless section between the plurality of wireless terminals and the base station;
the control device further includes a delay determiner configured to calculate a delay time on the basis of delay information of the wired section obtained from the relay device, the delay information of the wireless section included in the cooperation information, and the congestion delay in the wired section calculated by the traffic-based congestion calculator and determines whether or not the calculated delay time satisfies the request delay; and
the priority change controller transmits the control signal including the instruction to the relay device in a case where there is round-trip communication in which the delay time does not satisfy the request delay and in a case where all communication satisfies the request delay as a result of changing the priority.

6. The control device according to claim 1, wherein:
The control device according to claim 1, wherein:
the cooperation information includes at least delay information of a wireless section between the plurality of wireless terminals and the base station;
the control device further includes a delay determiner configured to calculate a delay time on the basis of delay information of the wired section obtained from the relay device, the delay information of the wireless section included in the cooperation information, the congestion delay in the wired section calculated by the traffic-based congestion calculator, and information regarding a processing time from reception of uplink traffic to transmission of downlink traffic measured in a host server of the relay device and determines whether or not the calculated delay time satisfies the request delay; and
the priority change controller transmits the control signal including the instruction to the relay device in a case where there is round-trip communication in which the delay time does not satisfy the request delay and in a case where all communication satisfies the request delay as a result of changing the priority.

7. A priority control method performed by a control device in a communication system in which one-way communication and round-trip communication coexist, the priority control method comprising:
based on cooperation information obtained from traffic transmitted from a plurality of wireless terminals and indicating a communication state between the plurality of wireless terminals and a base station that performs wireless communication, acquiring information regarding a request delay and information regarding a priority in the traffic for each piece of the traffic;
calculating a congestion delay in a wired section on the basis of the information regarding the request delay and the information regarding the priority acquired for each piece of the traffic; and
in a case where congestion occurs or a total delay requirement is not satisfied on the basis of the calculated congestion delay in the wired section, transmitting, to a relay device that relays the traffic, a control signal including an instruction to change a priority of traffic of the one-way communication or a priority of traffic of the round-trip communication such that the traffic of the one-way communication is preferentially transmitted.
